SEQUENCE LISTING (1 sequence)

SEQ ID NO: 1 - protein, 123 aa, Artificial Sequence
  Single domain antibody specific to a pathogen
QLQLQESGGGLVQPGGSLRLSCAASGFTFSSYAMSWFRQAPGKGLEWVGFIRSKAYGGTTEYAASVKGRFTISRDDSKSIAYLQMNSLRAEDTAMYYCARRAKDGYNSPEDYWGQGTLVTVSS

(19) United States
(12) Patent Application Publication
(10) Pub. No.: US 2011/0269148 A1
(43) Pub. Date: Nov. 3, 2011

(54) Nanoaggregate Embedded Beads Conjugated To Single Domain Antibodies

(75) Inventors: Ping-Ji Huang, Kaohsinng (TW); Lai-Kwan Chau, Chia-Yi (TW); Li-Lin Tay, Nepean (CA); Jamshid Tanha, Ottawa (CA)

(73) Assignees: NATIONAL CHENG CHUNG UNIVERSITY, Taiwan (CN); NATIONAL RESEARCH COUNCIL OF CANADA, Ottawa, ON (CA)

(21) Appl. No.: 13/130,344

(22) PCT Filed: Nov. 26, 2009
(86) PCT No.: PCT/CA2009/001728

§ 371 Date: Jul. 12, 2011

Related U.S. Application Data
(60) Provisional application No. 61/118,082, filed on Nov. 26, 2008.

(51) Int. Cl. G01N 21/65; B32B 5/16; G01N 21/00

(52) U.S. Cl. 435/7.1; 436/501; 428/403

(57) ABSTRACT

A nanoaggregate embedded bead is formed from an inner core formed of comprising metallic nanoparticles and Raman active reporter molecules, an outer shell, and single-domain antibodies to target the bead to a specific target. The nanoaggregate embedded bead may be used in methods to detect analytes or pathogens in biological or environmental samples using Raman spectroscopy.

### FIELD OF THE INVENTION

The present invention relates to nanoaggregate embedded beads conjugated to single domain antibody. More specifically, the present invention relates to nanoaggregate embedded beads conjugated to one or more single domain antibody and their use in analyte detection and identification by surface enhanced Raman spectroscopy.

### BACKGROUND OF THE INVENTION

The ability to detect and identify a single analyte from biological and other samples has widespread potential uses in medical diagnostics, pathology, toxicology, environmental sampling, chemical analysis and other fields. It is of critical importance, for example, to assess occurrence of chemical and biological pathogens in water, environmental, or biological samples. Current detection methods include, for example, immunological methods requiring fluorescently-labeled antibodies that bind to pathogens, and amplification of pathogens through culturing steps. Such methods are time-consuming, and lack sensitivity and specificity; for example, if an antibody reacts with numerous targets other than the pathogen of interest, false positive results are obtained. Fluorescent nanoparticles achieve single cell detection, but are susceptible to photobleaching, spectral blinking and spectral overlapping problems (Zhao et al., 2004).

Raman spectroscopy provides information about the vibrational state of molecules. Such molecules are able to absorb incident radiation that matches a transition between two of its allowed vibrational states and to subsequently emit the radiation. Absorbed radiation is re-radiated at the same wavelength (Rayleigh or elastic scattering). In some instances, the re-radiated radiation can contain slightly more or slightly less energy than the absorbed radiation, depending upon the allowable vibrational states and the initial and final vibrational states of the molecule. The result of the energy difference between the incident and re-radiated radiation is manifested as a shift in the wavelength between the incident and re-radiated radiation, and the degree of difference is designated the Raman shift (RS), measured in units of wavenumber (inverse length). If the incident light is monochromatic (single wavelength), as it is when using a laser source, the scattered light which differs in frequency can be more easily distinguished from the Rayleigh scattered light.

The probability of Raman interaction occurring between an excitation light beam and an individual molecule in a sample is very low, resulting in a low sensitivity and limited applicability of Raman analysis. However, surface enhanced Raman scattering or spectroscopy (SERS) results in the enhancement of Raman scattering by molecules adsorbed on rough metal surfaces. The enhancement factor can be as much as 10¹⁴ to 10¹⁵, which allows SERS to be sensitive enough to detect single molecules (Kneipp et al., 1997; Xu et al., 1999; Michaels et al., 1999). Since Raman relaxation time is extremely short, photobleaching is not an issue. Raman vibrational bands of typical organic molecules are also much narrower than those of fluorescent molecules.

The SERS effect is related to the phenomenon of surface plasmon resonance. When light of appropriate frequency is incident on metal nanoparticles (or nanostructures), the collective excitation of the conduction electron in the metal nanoparticles results in the form of localized surface plasmon resonance. This causes the incident and scattered electromagnetic field (hence energy) to be concentrated to a very small region of the nanoparticle. Metal nanoparticles, thus, function as miniature antennae to enhance the localized effects of electromagnetic radiation. Molecules located in the vicinity of such particles will experience the highly localized field and its Raman emission is greatly amplified. This amplification can be further strengthened by coupling nanostructures to allow their localized surface plasmon resonance to interact. Thus, with molecules placed in the interparticle junction of a small aggregate of nanoparticles and excited with radiations polarized along the interparticle axis generates highly enhanced Raman emission from the molecular vibration (Moskovits, 1985; 2005).

Attempts have been made to exploit SERS for molecular detection and identification. In biological applications, the colloidal form of nanoparticles is most beneficial as it can be manipulated in the physiological condition. In bioanalytical applications, nanoparticle-antibody conjugates enable ultra-sensitive transduction with added specificity. Typically, each nanoparticle can be conjugated to multiple antibodies, resulting in strong, multivalent interaction between the conjugates and the cell surface antigens, thus enhancing avidity between the two. The increase in avidity has been reported previously, but is generally small, only an eight times increase in intrinsic affinity and a four-fold decrease in dissociation over the monomeric antibody (Soukka et al., 2001; Valanne et al., 2005).

Colloidal metallic nanoparticles provide sensitivity but suffer from instability and parasitic signals from contaminant molecules. Colloidal nanoparticles tend to aggregate catastrophically in the relatively high salt concentration of physiological buffer solutions. Coating the nanoparticles ameliorates both aggregation and contamination problems. Traditional antibodies are generally large, posing difficulty in their attachment and orientation on the surfaces of nanoparticles. Antibodies anchored to such surfaces may be unable to participate in interactions with antigens since the active site can be sterically hindered or inaccessible. The size of traditional antibodies limits the number which can be anchored to the surface. Antigen-binding fragments (Fabs) and single chain variable fragments (scFv) are often used to better control the surface coverage and geometry of the active sites of the antigen binder. However, scFvs form dimers and higher oligomers where the V_{H} and V_{L} of one scFv associate with the V_{H} and V_{L} of another scFv, which can lead to aggregation and other complex mixtures in solution. The same problems occur when scFv are anchored to the nanoparticle surface, compromising functionality.

### SUMMARY OF THE INVENTION

The present invention relates to nanoaggregate embedded beads conjugated to a single domain antibody. More specifically, the present invention relates to nanoaggregate embedded beads conjugated to one or more single domain antibodies and their use in analyte detection and identification by surface enhanced Raman spectroscopy.

The present invention provides a nanoaggregate embedded bead, comprising:
(a) an inner core comprising one or more metallic nanoparticles and one or more Raman active reporter molecules;
(b) an outer shell; and
(c) one or more single-domain antibody (sdAb).

The metallic nanoparticles of the nanoaggregate embedded bead may be selected from gold, silver, copper, aluminium, their alloys, or combinations thereof; in a specific example, the metallic nanoparticles may be gold or silver nanoparticles. The Raman-active reporter molecule may comprise at least one organic compound; the organic compound may comprise at least one isothiocyanate, thiol, or amine group, or multiple sulfur atoms, or multiple nitrogen atoms. For example, the organic compound may comprise rhodamine 6G (R6G), tetramethyl-rhodamine-5-isothiocyanate, X-rhodamine-5-(and -6)-isothiocyanate, or 3,3′-diethylthiadicarbocyanine iodine. The outer shell of the nanoaggregate embedded bead may comprise silica or polymer.

The single-domain antibody (sdAb) of the nanoaggregate embedded bead described above may be specific for a target. The sdAb may be specific to a pathogen. For example, and without wishing to be limiting, the sdAb may be specific to protein A on the surface of Staphylococcus aureus. This sdAb may comprise the sequence

[SEQ ID NO. 1]
QLQLQESGGGLVQPGGSLRLSCAASGFTFSSYAMSWFRQAPGKGLEWVG
FIRSKAYGGTTEYAASVKGRFTISRDDSKSIAYLQMNSLRAEDTAMYYC
ARRAKDGYNSPEDYWGQGTLVTVSS,

or a substantially identical sequence thereto. The sdAb may be HVHP428.

The present invention also provides a method of identifying an analyte in a sample, comprising the steps of:
(a) contacting the sample with a nanoaggregate embedded bead as described herein, wherein the sdAb specifically binds to the analyte; and
(b) detecting the nanoaggregate embedded bead with surface enhanced Raman scattering spectroscopy or microscopy.

Also, there is provided a method of detecting one or more than one pathogen of interest in a mixed culture or sample, comprising the steps of:
(a) binding the pathogen with a nanoaggregate embedded bead as described herein, wherein the sdAb is specific for the pathogen; and
(b) detecting the nanoaggregate embedded bead with surface enhanced Raman scattering spectroscopy or microscopy.

In one embodiment, the pathogen may be selected from the group consisting of Staphylococcus aureus, Francisella tularensis, Salmonella, E. coli O157:H7, Shigella, Clostridium difficile, and Listeria. In a specific example, the pathogen may be S. aureus.

Since single domain antibodies target specific pathogens, detection of the pathogens of interest is achieved with sensitivity and reliability. Further, single domain antibodies are smaller in size compared to whole antibodies, facilitating control of the orientation and surface coverage of active sites on the nanoaggregate embedded beads. The instability problem is largely avoided, while the ultra-sensitivity of the SERS effect is retained. The increased avidity is large in comparison to those of conventional antibody-nanoparticle conjugates. Without limitation to a theory, the increased avidity may be related to the single domain antibody circumventing the aggregation problem commonly encountered with scFvs.

The nanoaggregate embedded beads (NAEBs) of the present invention may be used for various methods, including, for example, detection and classification of bacteria and microorganisms for biomedical uses and medical diagnostic uses, infectious disease detection (for example, in hospitals), breath applications, body fluids analysis, pharmaceutical applications, monitoring and quality control of food and water supply, beverage and agricultural products, environmental toxicology, fermentation process monitoring and control applications, detection of biological warfare agents and agro-terrorism agents, and the like.

In a clinical setting, the standardized screening procedure for S. aureus relies on a laborious and lengthy cell culture process followed by a coagulase test that can take more than a week to generate results. While the PCR (polymerase chain reaction)-based assay reduces the detection time down to two days, it is still too long for rapid diagnosis applications. The high cost associated with the high sensitivity commercial PCR test kits further highlights the advantage of the proposed SERS detection platform. The sdAb-NAEB probe can be batch synthesized and gives results within one hour. Thus, sdAb-NAEB-based SERS detection provides a more sensitive, faster, and more economical option than the standard S. aureus assay. Similar advantages exist for the detection of other pathogens.

Furthermore, use of the sdAb as the recognition unit also renders the probe highly specific, which thus improves the accuracy of detection over conventional screening techniques. In addition, NAEBs can be synthesized to carry different Raman reporter molecules, thus affording great potential for multiplexed detection. Although a similar analytical detection process can be carried out by using a fluorescence probe, photobleaching of molecular fluorophores or blinking and quenching problems associated with fluorescent quantum dots limits their potential application. In the case of NAEBs, well-established silane chemistry allows for simple and reliable conjugation of sdAb, whereas bioconjugation of the above-mentioned fluorescent probes requires significant effort to optimize.

SERS-active NAEBs may be fabricated to optimise sensitivity, and can be used as high sensitivity receptors for the recognition and targeted detection of pathogenic microorganisms. In one embodiment, an S. aureus recognizing sdAb is conjugated on the NAEB surface, thereby enabling targeted binding and detection of S. aureus cells. The multivalent nature of the sdAb functionalized NAEB allows the detection of S. aureus cells at a particle concentration of 0.39 nm in microagglutination assay studies. In one embodiment, the high sensitivity of NAEBs as an SERS transducer allows the detection of a single S. aureus cell.

### BRIEF DESCRIPTION OF THE DRAWINGS

In the drawings, like elements are assigned like reference numerals. The drawings are not necessarily to scale, with the emphasis instead placed upon the principles of the present invention. Additionally, the embodiments depicted are but a few of a number of possible arrangements utilizing the fundamental concepts of the present invention. The drawings are briefly described as follows:

FIG. 1 is a schematic representation of an embodiment of the present invention.

FIG. 2 is a schematic representation of methods for producing the nanoaggregate embedded beads-single domain antibody (HVHP428 V_{H}) conjugates of the present invention.

FIG. 3A shows an extinction spectra of colloidal Au sol (dashed line) and NAEBs in absence of antibody (solid line). FIG. 3B shows a typical R6G-SERS spectrum of R6G-NAEBs. FIG. 3C shows a transmission electron microscopy (TEM) image of NAEBs of the present invention.

FIG. 4 shows fluorescence spectra of control sdAb (lower black trace) and sdAb-NAEB (upper black trace and grey trace) treated with protein A-PE. Upper black trace was generated from conjugation of sdAb antibody to NAEB at a loading ratio of 125 while grey trace from a higher loading ratio of 250.

FIG. 5A shows microagglutination assay of NAEBs of the present invention against S. aureus and S. typhimurium. Rows 1 and 2 are S. aureus cells exposed to control NAEBs and sdAb-NAEBs, respectively. Rows 3 and 4 are S. typhimurium exposed to control NAEBs and sdAb-NAEBs, respectively. FIG. 5B is a SEM image of the control NAEBs against S. aureus. FIG. 5C is a SEM image of sdAb-NAEBs against S. aureus. FIG. 5D is a SEM image of sdAb-NAEBs against S. typhimurium. Scale bars in FIGS. 5B to D are 1 μm long.

FIG. 6A shows a SEM image of the S. aureus cells treated with control NAEB. FIG. 6B shows an optical image, and FIG. 6C the Raman intensity map obtained from the integrated intensity of 1040 to 2000 cm⁻¹ spectral region. FIG. 6D shows the Raman spectrum obtained from the bright spot in FIG. 6C. The inset of FIG. 6D shows a typical S. aureus Raman spectrum from a cluster of S. aureus cells (image not shown).

FIGS. 7A-D demonstrate the detection of a single S. aureus cell using the nanoaggregate embedded beads of the present invention. The single domain antibody bound specifically to S. aureus. FIG. 7A is a scanning electron microscope (SEM) image of Staphylococcus aureus cells labeled with nanoaggregate embedded beads-single domain antibody conjugates of the present invention. FIG. 7B is a corresponding optical image of the S. aureus cells of FIG. 7A. FIG. 7C is a surface enhanced Raman scattering (SERS) intensity map of the S. aureus cells of FIG. 7A, showing the SERS detection of a single S. aureus cell labeled with nanoaggregate embedded beads-single domain antibody conjugates of the present invention. FIG. 7D is a SERS spectrum of rhodamine 6G-nanoaggregate embedded beads.

### DETAILED DESCRIPTION OF PREFERRED EMBODIMENTS

The present invention relates to nanoaggregate embedded beads conjugated to single domain antibody. More specifically, the present invention relates to nanoaggregate embedded beads conjugated to one or more single domain antibody and their use in analyte detection and identification by surface enhanced Raman scattering.

When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

In one embodiment, the present invention provides a nanoaggregate embedded bead (NAEB) comprising:
(a) an inner core comprising one or more metallic nanoparticles and one or more Raman active reporter molecules;
(b) an outer shell; and
(c) one or more single-domain antibody (sdAb).

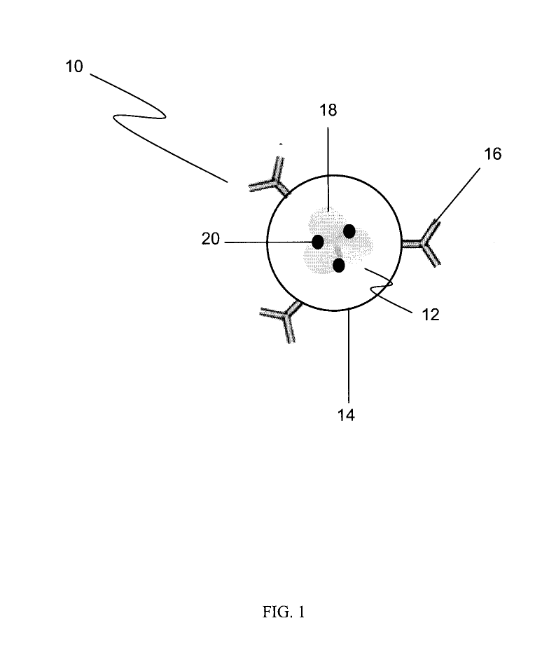

The nanoaggregate embedded bead of the present invention comprises a surface enhanced Raman scattering (SERS)-active nanoparticle and utilizes the basic principle of SERS enhancement to achieve ultra-sensitive detection. One embodiment of the nanoaggregate embedded bead (10) is generally shown in FIG. 1 to comprise an inner core (12), an outer shell (14), and one or more single-domain antibody (16). The inner core (12) is formed of one or more metallic nanoparticles (18) aggregated with one or more Raman active reporter molecules (20). The inner core (12) is encapsulated by the outer shell (14), which provides a surface onto which the sdAb (16) is attached.

As used herein, the term “nanoparticle” means a particle having at least one dimension which is less than about 200 nm.

The metallic nanoparticles (18) may comprise any suitable metallic material known in the art. In general, any metals and doped semiconductors that can sustain SERS are suitable for use in the present invention. For example, the metallic nanoparticles may comprise, but are not limited to gold, silver, or copper, aluminium, or alloys thereof, or a combination thereof. In a specific, non-limiting example, the metallic nanoparticles may be gold, silver or copper nanoparticles. Methods of preparing metallic nanoparticles are well-known to those of skill in the art (Lee, 1982; Baker et al. 2005), and are not further described herein.

The metallic nanoparticles may be of a suitable size and type. For example, and without wishing to be limiting, the average particle size (i.e., diameter) may be in the range of about 1 to 100 nm; for example, the average size of the metallic nanoparticles may be about 1, 2, 5, 10, 15, 20, 25, 30, 35, 40, 45, 50, 55, 60, 65, 70, 75, 80, 85, 90, 95, or 100 nm, or any amount therebetween, or any range defined by the values just recited.

One or more than one Raman active reporter molecule may be adsorbed onto the metallic nanoparticles (20) or otherwise aggregated with the nanoparticles. The Raman-active reporter molecule may comprise at least one organic compound; the organic compound at least one isothiocyanate, thiol, or amine group, or multiple sulfur atoms, or multiple nitrogen atoms. For example, the Raman-active reporter molecule may be, but is not limited to rhodamine 6G, tetramethyl-rhodamine-5-isothiocyanate, X-rhodamine-5-(and -6)-isothiocyanate, or 3,3′-diethylthiadicarbocyanine iodine, or a combination thereof. In a specific, non-limiting example, the Raman-active reporter molecule may rhodamine 6G (R6G).

The inner core (12) is encapsulated by the outer shell (14). The outer shell may be formed of any suitable material known in the art; for example, and not wishing to be limiting in any manner, the shell may comprise silica, or one or more than one biocompatible polymer, for example and not limited to a block copolymer. In a specific, non-limiting example, the outer shell may be comprised of silica (glass) or other suitable material. The silica shell provides the inner core (12) with mechanical and chemical stability, sequesters the inner core (12) from exterior reactions, and renders the inner core (12) amenable to use in many solvents without disrupting the SERS response. Further, the outer shell prevents other analytes from entering SERS hot sites to displace the signal of the active reporter molecule (20). Additionally, the outer shell enables attachment of biomolecules. This core+shell architecture is familiar to the skilled artisan. Methods for preparing the silica shell are also well-known to those of skill in the art (see for example, Lu et al, 2002; Kell et al, 2008).

The thickness of the silica shell or coating may vary. For example, and without wishing to be limiting in any manner, the thickness of the silica coating may be applied in a controlled manner over the metallic nanoparticle-Raman reporter core. The thickness of the silica coating, once complete, may be about 1 nm and 100 nm, or any value there between; for example, the silica coating may be about 1, 5, 10, 15, 20, 25, 20, 25, 40, 45, 50, 55, 60, 65, 70, 75, 80, 85, 90, 95, or 100 nm thick, or any value therebetween. In a specific, non-limiting example, the thickness of the silica coating may be about 70 nm.

The nanoaggregate embedded bead of the present invention comprises one or more than one single-domain antibody (sdAb; 16). By the term “single-domain antibody”, it is meant an antibody fragment comprising a single protein domain. Single domain antibodies may comprise any variable fragment, including V_{L}, V_{H}, V_{H}H, V_{NAR}, and may be naturally-occurring or produced by recombinant technologies. For example V_{H}S, V_{L}S, V_{H}HS, V_{NAR}S, may be generated by techniques well known in the art (Holt, et al., 2003; Jespers, et al., 2004a; Jespers, et al., 2004b; Tanha, et al., 2001; Tanha, et al., 2002; Tanha, et al., 2006; Revets, et al., 2005; Holliger, et al., 2005; Harmsen, et al., 2007; Liu, et al., 2007; Dooley, et al., 2003; Nuttall, et al., 2001; Nuttall, et al., 2000; Hoogenboom, 2005; Arbabi-Ghahroudi et al., 2008). In the recombinant DNA technology approach, libraries of sdAbs may be constructed in a variety of ways, “displayed” in a variety of formats such as phage display, yeast display, ribosome display, and subjected to selection to isolate binders to the targets of interest (panning). Examples of libraries include immune libraries derived from llama, shark or human immunized with the target antigen; non-immune/naïve libraries derived from non-immunized llama, shark or human; or synthetic or semi-synthetic libraries such as V_{H}, V_{L}, V_{H}H or V_{NAR} libraries.

Single domain antibodies have only one domain and are smaller in size compared to the sizes of whole antibodies (i.e., Fabs and scFvs), thereby minimizing aggregation during conjugation with nanoparticles. Despite smaller binding surfaces, their demonstrated affinity is comparable to that demonstrated by scFv fragments. Due to their simpler structure, single domain antibodies are highly stable and have simpler folding properties, making them very efficacious for a range of life science, medical and other applications.

As would be understood by one of skill in the art, sdAbs specific to a wide range of molecules would be useful in the present invention. For example, the sdAb could specifically bind to molecules present on specific cell or tissue types or on different organisms. For example, and without wishing to be limiting in any manner, the sdAb may recognize various pathogens.

By the term “pathogen”, it is meant any human pathogen or those of animals or plants, including bacteria, eubacteria, archaebacteria, eukaryotic microorganisms (e.g., protozoa, fungi, yeasts, and molds), viruses, and biological toxins (e.g., bacterial or fungal toxins or plant lectins). Pathogens include, but are not limited to Staphylococcus aureus, Francisella tularensis, Salmonella, E. coli O157:H7, Shigella, C. difficile, and Listeria. In one non-limiting example, the sdAb may be specific to protein A on the surface of Staphylococcus aureus, in particular the methicillin-resistant varieties (MRSA).

In one embodiment, the sdAb may comprise a heavy variable domain (V_{H}) denoted as HVHP428. HVHP428 belongs to a small subset of V_{H}S that can interact with protein A on S. aureus cell surfaces and has binding specificity towards S. aureus protein A (K_{A}=5.6×10⁵ M⁻¹) (To et al, 2005). In a specific, non-limiting example, the sdAb may comprise the sequence

(SEQ ID NO: 1)
QLQLQESGGGLVQPGGSLRLSCAASGFTFSSYAMSWFRQAPGKGLEWVG
FIRSKAYGGTTEYAASVKGRFTISRDDSKSIAYLQMNSLRAEDTAMYYCA
RRAKDGYNSPEDYWGQGTLVTVSS,

or a sequence substantially identical thereto. The hypervariable loops/complementarity-determining regions (H/CDRs) are underlined.

A sequence that is substantially identical to another may comprise one or more conservative amino acid mutations. It is known in the art that one or more conservative amino acid mutations to a reference sequence may yield a mutant polypeptide with no substantial change in physiological, chemical, or functional properties compared to the reference sequence; in such a case, the reference and mutant sequences would be considered “substantially identical” polypeptides. Conservative amino acid mutation may include addition, deletion, or substitution of an amino acid; a conservative amino acid substitution is defined herein as the substitution of an amino acid residue for another amino acid residue with similar chemical properties (e.g. size, charge, or polarity).

In a non-limiting example, a conservative mutation may be an amino acid substitution. Such a conservative amino acid substitution may substitute a basic, neutral, hydrophobic, or acidic amino acid for another of the same group. By the term “basic amino acid” it is meant hydrophilic amino acids having a side chain pK value of greater than 7, which are typically positively charged at physiological pH. Basic amino acids include histidine (H is or H), arginine (Arg or R), and lysine (Lys or K). By the term “neutral amino acid” (also “polar amino acid”), it is meant hydrophilic amino acids having a side chain that is uncharged at physiological pH, but which has at least one bond in which the pair of electrons shared in common by two atoms is held more closely by one of the atoms. Polar amino acids include serine (Ser or S), threonine (Thr or T), cysteine (Cys or C), tyrosine (Tyr or Y), asparagine (Asn or N), and glutamine (Gln or Q). The term “hydrophobic amino acid” (also “non-polar amino acid”) is meant to include amino acids exhibiting a hydrophobicity of greater than zero according to the normalized consensus hydrophobicity scale of Eisenberg (1984). Hydrophobic amino acids include proline (Pro or P), isoleucine (Ile or I), phenylalanine (Phe or F), valine (Val or V), leucine (Leu or L), tryptophan (Trp or W), methionine (Met or M), alanine (Ala or A), and glycine (Gly or G). “Acidic amino acid” refers to hydrophilic amino acids having a side chain pK value of less than 7, which are typically negatively charged at physiological pH. Acidic amino acids include glutamate (Glu or E), and aspartate (Asp or D).

Sequence identity is used to evaluate the similarity of two sequences; it is determined by calculating the percent of residues that are the same when the two sequences are aligned for maximum correspondence between residue positions. Any known method may be used to calculate sequence identity; for example, computer software is available to calculate sequence identity. Without wishing to be limiting, sequence identity can be calculated by software such as NCBI BLAST2 service maintained by the Swiss Institute of Bioinformatics (and as found at http://ca.expasy.org/tools/blast/), BLAST-P, Blast-N, or FASTA-N, or any other appropriate software that is known in the art.

The substantially identical sequences of the present invention may be at least 75% identical; in another example, the substantially identical sequences may be at least 70, 75, 80, 85, 90, 95, or 100% identical at the amino acid level to sequences described herein. Importantly, the substantially identical sequences retain the activity and specificity of the reference sequence.

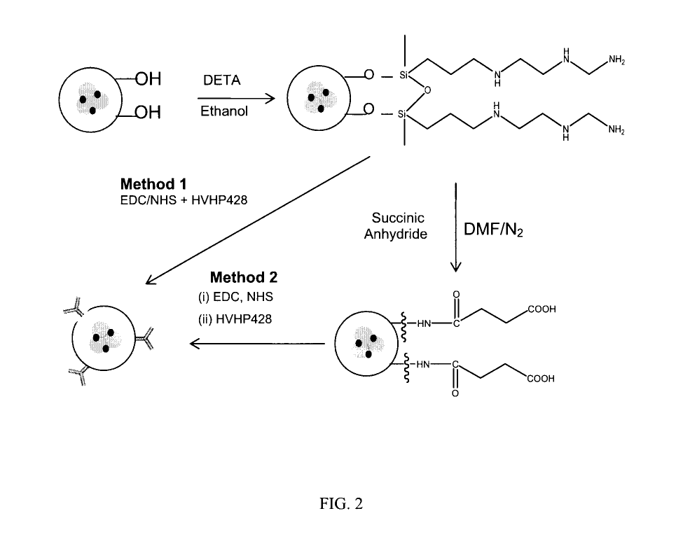

The sdAb may be conjugated (also referred to herein as “bioconjugated”, “linked”, or “coupled”) to the outer shell of the nanoaggregate embedded bead. Conjugation of sdAbs to the nanoaggregate embedded bead may be accomplished using methods well known in the art (see for example Hermanson, 1996). Bioconjugation reactions are used to anchor single domain antibodies to carboxylic acid and amine-modified nanoaggregate embedded beads, as exemplified in FIG. 2.

For example, single domain antibodies have several exposed lysine (primary amine) residues, and thus, one method of covalently anchoring the sdAb to the carboxylic acid-modified outer shell surface is through bioconjugation chemistry. For example, the sdAb as described above may have, or may be engineered to have, one or more lysine residues opposite or away from its antigen binding site, which is used in covalent conjugation to the nanoparticle surface. Suitable coupling reagents for bioconjugation include, but are not limited to 1-ethyl-3-(3-dimethylaminopropyl) carbodiimide hydrochloride (EDC) which is often used in combination with N-hydroxysuccinimide (NHS).

Alternatively, the sdAb may be conjugated to the nanoconjugate outer shell through an amino acid with a carboxylic acid (i.e., Glu or Asp) on the sdAb and primary amines on the outer shell, or through binding of the sdAb (detecting entity) to a molecule, e.g., a protein already attached to the nanoparticle and has binding activity towards the sdAb. For example, this could be an antibody that binds to the sdAb or to tags (C-Myc tag, His6 tag) on the sdAb such as anti-C-Myc or anti-His6 antibodies, or through binding of the biotinylated sdAb to a biotin binder on the surface of nanoparticles, e.g., streptavidin, neutravidin, avidin, extravidin. The sdAb could also be coupled to the nanoparticle by means of nickel-nitrilotriacetic acid chelation to a His6-tag.

In another alternative, single-domain antibodies can also be engineered to have cysteines opposite their antigen binding sites. Conjugation via a maleimide cross-linking reaction allows the directional display of single domain antibodies where all single domain antibodies are optimally positioned to bind to their antigens. Amine-terminated NAEB is activated with maleimide in DMF followed by an incubation of cysteine-terminated single domain antibody to achieve covalent binding through the formation of sulfide bond formation.

In yet another alternative, the single domain antibody may be non-covalently conjugated to the surface of a nanoaggregate embedded bead by passive adsorption.

The number of single domain antibodies anchored to the outer shell (14) may be easily controlled; thus, the number of single domain antibodies to fully enhance the multivalency effect can be established. The NAEB of the present invention may comprise at least 1 to 250 sdAb molecules conjugated to the surface of the NAEB; for example, the conjugate may carry at least 1, 10, 20, 30, 40, 50, 60, 70, 80, 90, 100, 110, 120, 130, 140, 150, 160, 170, 180, 190, 200, 210, 220, 230, 240, or 250 sdAb moieties, or any amount therebetween, linked to the NAEB. In a specific, non-limiting embodiment, the conjugate may comprise about 125 sdAb molecules. As a person of skill in the art would recognize, it may be possible to conjugate more or less sdAb molecules to the surface of the nanoparticle, depending on particle size, sdAb size and characteristics, and on immobilization efficiency.

It is to be noted that each of the sdAb molecules linked to the nanoparticle may be the same, or may differ from one another. Thus, the nanoaggregate embedded bead may be conjugated to more than one single domain antibody to detect multiple pathogens simultaneously. The nanoaggregate embedded beads may be conjugated to different single domain antibodies which recognize different parts (epitopes) on the same pathogen, e.g., different epitopes on the same toxin or different epitopes on the same bacterial cell surface molecules or different epitopes on different cell surface molecules of the same bacteria.

The nanoaggregate embedded bead (10) may be approximately spherically shaped, although other regular or irregular shapes may also be appropriate. As will be recognized by those skilled in the art, the diameter of the nanoaggregate embedded beads may vary depending on the individual components (metallic nanoparticle, precursor, etc) used and the antibody and the number of copies conjugated to the outer shell. Without wishing to be limiting in any manner, the overall size of the nanoconjugate of the present invention may be between about 50 and 250 nm in diameter. For example, and without wishing to be limiting, the nanoconjugate may have a diameter of about 50, 60, 70, 80, 90, 100, 110, 120, 130, 140, 150, 160, 170, 180, 190, 200, 210, 220, 230, 240, or 250 nm, or any value therebetween. In a specific, non-limiting example, the nanoconjugate diameter may be about 150 nm.

The present invention also provides methods for producing the nanoaggregate embedded beads. In one embodiment, the metallic nanoparticles are pre-aggregated with a Raman-active reporter molecule and subsequently encased in the outer shell. The sdAb are then bioconjugated to the outer shell.

The present invention further provides methods of identifying an analyte in a sample. Such methods may be performed, for example, by contacting a sample with the nanoaggregate embedded beads described above, wherein the sdAb specifically binds to the analyte; detecting SERS signals upon contacting the sample with the nanoaggregate embedded beads; and associating the surface enhanced Raman scattering signals with the identity of the analyte.

As used herein, the term “analyte” means any atom, chemical, molecule, compound, composition or aggregate of interest for detection and/or identification. Non-limiting examples of analytes include an amino acid, peptide, polypeptide, protein, glycoprotein, lipoprotein, nucleoside, nucleotide, oligonucleotide, nucleic acid, sugar, carbohydrate, oligosaccharide, polysaccharide, fatty acid, lipid, hormone, metabolite, cytokine, chemokine, receptor, neurotransmitter, antigen, allergen, antibody, substrate, metabolite, cofactor, inhibitor, drug, pharmaceutical, nutrient, prion, toxin, poison, explosive, pesticide, chemical or biological warfare agent, biohazardous agent, radioisotope, vitamin, carcinogen, mutagen, waste product and/or contaminant, and pathogen. The analyte may be present in a sample.

As used herein, the term “sample” means a sample which may contain an analyte of interest. A sample may comprise a body fluid or tissue (for example, urine, blood, plasma, serum, saliva, ocular fluid, spinal fluid, gastrointestinal fluid and the like) from humans or animals; plant tissue, an environmental sample (for example, municipal and industrial water, sludge, soil, atmospheric air, ambient air, and the like); food; and beverages. A “mixed culture” may comprise various types of bacterial cells, or a mixture of different cell types.

The invention also encompasses methods of identifying a pathogen in sample or mixed culture. The nanoaggregate embedded beads can participate in multivalent interactions and strongly bind pathogens for detection and identification by surface enhanced Raman scattering spectroscopy. Such methods can be performed, for example, by contacting a sample or mixed culture with the nanoaggregate embedded beads, wherein the single domain antibody is specific for the pathogen; detecting SERS signals upon contacting the sample with the nanoaggregate embedded beads-single domain antibody conjugate; and associating the SERS signals with the identity of the microorganism.

In one embodiment, the nanoaggregate embedded beads bind pathogens such as

Staphylococcus aureus, Francisella tularensis, Salmonella, E. coli O157:H7, Shigella, C. difficile, and Listeria. In one embodiment, the nanoaggregate embedded beads-single domain antibody conjugate binds S. aureus.

The nanoaggregate embedded bead may be conjugated to more than one single domain antibody to detect multiple pathogens simultaneously. In one embodiment, nanoaggregate embedded beads may be conjugated to different single domain antibodies which recognize different parts (epitopes) on the same pathogen, e.g., different epitopes on the same toxin or different epitopes on the same bacterial cell surface molecules or different epitopes on different cell surface molecules of the same bacteria.

The invention also encompasses systems for detecting an analyte in a sample. For example, and without wishing to be limiting, the system includes a plurality of nanoaggregate embedded beads; a Raman spectrometer; and a computer operatively linked to the spectrometer including an algorithm for analysis of the sample.

The nanoaggregate embedded beads may be part of a detection platform designed to detect and quantify pathogens by Raman spectroscopy. The detection platform can include, but is not limited to a Raman spectrometer, a microscope, an information processing system incorporating a computer for communication information; a processor for processing information; data gathering, storage, analysis and reporting software; and peripheral devices known in the art, such as memory, display, keyboard and other devices.

The nanoaggregate embedded beads of the present invention may also be part of a binding assay to detect pathogens in sample at very low bacterial counts; or part of a microfluidic system, where the use of nanostructures within microfluidic systems may prevent clogging.

It has previously been demonstrated that preparations of a single-domain antibody pentamer dramatically increases its binding with respect to the monomeric single domain antibody to a protein A ligand, which is rich on the surface of the pathogenic bacteria S. aureus (Ryan et al., 2009). What was not known is whether a monomeric single domain antibody could successfully be attached to nanoaggregate embedded beads, and further could achieve similar avidity enhancements.

It is presently shown that, in microagglutination assays involving S. aureus, the nanoaggregate embedded beads of the present invention agglutinated the cells more than 100-fold better that the pentamer, suggesting that the attached single domain antibodies may have a geometry that allows for a more sensitive detection of pathogenic bacteria (Huang et al., 2009).

Since single domain antibodies target specific pathogens, detection of the pathogens of interest is achieved with greater sensitivity and reliability. Further, single domain antibodies are smaller in size compared to whole antibodies, facilitating control of the orientation and surface coverage of active sites on the nanoaggregate embedded beads. The increased avidity is extremely large in comparison to those of conventional antibody-nanoparticle conjugates, which may be related to the single domain antibody circumventing the aggregation problem commonly encountered with scFvs.

Commercial applications for embodiments of the invention include, for example, detection and classification of bacteria and microorganisms for biomedical uses and medical diagnostic uses, infectious disease detection (for example, in hospitals), breath applications, body fluids analysis, pharmaceutical applications, monitoring and quality control of food and water supply, beverage and agricultural products, environmental toxicology, fermentation process monitoring and control applications, detection of biological warfare agents and agro-terrorism agents, and the like.

As will be apparent to those skilled in the art, various modifications, adaptations and variations of the foregoing specific disclosure can be made without departing from the scope of the invention claimed herein.

### EXAMPLES

The following examples are intended to illustrate embodiments of the described invention, and not to be limiting of the claimed invention unless explicitly stated.

### Example 1

### Silica-Coated Gold Nanoparticle Embedded Beads

Gold nanoparticles with a mean diameter of 12 nm were synthesized according to the literature procedures (Frens, 1973), which are well known to those skilled in the art. Controlled aggregation of the gold nanoparticles was achieved by adjusting the pH value of the colloidal sol prior to the addition of Raman-active reporter molecule by methods known in the art (Huang et al, 2009b). The pH value of the gold sol was adjusted to ˜10 with 100 mM NaOH. A solution of R6G (10⁻⁴ M) was introduced under vigorous stirring and allowed to equilibrate for 15 min. The concentration of the Raman reporter rhodamine 6G (R6G; Molecular Probes, Eugene Oreg.) after equilibration was 10⁻⁶ M. A coupling reagent, (3-mercaptopropyl)trimethoxysilane (MPTMS) in ethanol (˜10⁻⁴ M), was then added to the R6G/gold nanoparticles solution and allowed to equilibrate for another 15 min. The final concentration of MPTMS was about 6×10⁻⁷ M.

Silica coating was achieved by a modified Stöber process. A solution of dye-induced gold-nanoaggregates was mixed with 16 mL of ethanol in a 50 mL glass tube. 0.5 mL of 33 wt. % ammonia was added to the glass tube under vigorous shaking, followed by the addition of 1.2 mL of 95 mM tetraethyl orthosilicate in ethanol sixteen times within 8 h (at a time interval of 0.5 h). After injection of the tetraethyl orthosilicate/ethanol solution, the mixture was allowed to react for 12 h. The mixture was then centrifuged at 8000 rpm for 10 min. The precipitated nanoaggregate embedded beads (NAEB) were redispersed into ethanol.

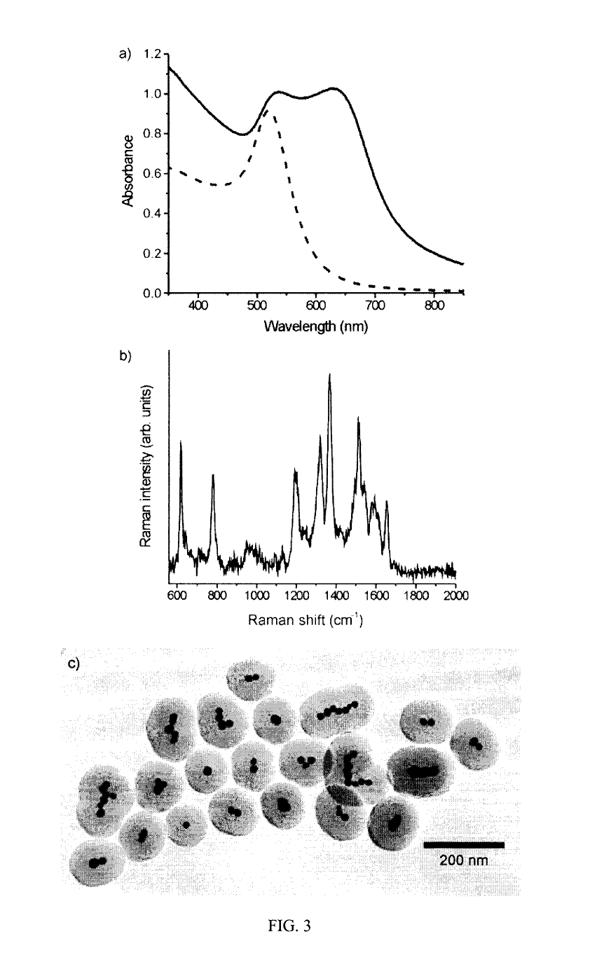

Formation of nanoaggregates in the colloidal Au sol was demonstrated by the change in color and the extinction response, as shown in FIG. 3A. Monodispersed Au sol exhibits an absorption maximum at λ=520 nm prior to the addition of R6G. The absorption response of NAEBs showed an additional peak at λ=640 nm, indicative of the nanoaggregates structure. A transmission electron microscopy (TEM) image of the NAEBs (FIG. 3C) shows that the majority of NAEBs are composed of 2-5 NPs encapsulated in a dense silica shell and have a typical dimension of ˜150 nm. A typical SERS spectrum of R6G-NAEB is shown in FIG. 3B.

### Example 2

### Surface Modification of the Nanoaggregate Embedded Beads (NAEB)

Before immobilizing sdAbs onto the NAEBs, the surfaces of NAEBs were chemically modified. To form the amine-functionalized group on the NAEBs surface, 3.0 mL of 1.0×10¹³/mL NAEBs were reacted with 18.75 μL, of DETA in ethanol at room temperature in an overnight incubation. The solution was then held at a low boil for 1 h to promote covalent bonding of the organosilane to the silica surface of NAEB (Westcott et al, 1998). The solution was then centrifuged and redispersed in ethanol at least four times to remove excess reactants. The particles were then washed and re-dispersed in DMF. Grafting of carboxylate terminal group is accomplished by reacting the amine-terminated NAEBs with 10% succinic anhydride in DMF solution under N₂ gas in an overnight reaction with continuous stirring (Levy et al, 2002). This results in the formation of carboxylate groups onto the NAEBs surface and prepares the beads for further conjugation with sdAbs.

### Example 3

### Conjugation of sdAb

Conjugation of a single domain antibody, HVHP428 (To et al., 2005), to the nanoaggregate embedded bead prepared in Example 2 was achieved by activating the carboxylate functional group of the single domain antibody. Suitable reagents include 1-ethyl-3-(3-dimethylaminopropyl) carbodiimide hydrochloride (EDC) which is often used in combination with N-hydroxysuccinamide (NHS) to increase coupling efficiency or to create a stable product.

In Method 1, carboxylate functional group of the single domain antibody was activated by EDC and NHS coupling agent. The activated single domain antibody was then incubated with amine modified NAEB overnight at 4° C., followed by PBS buffer wash to remove unbound protein.

In Method 2, carboxylated-NAEBs were activated using EDC and NHS in PBS buffer (pH 7.0) for 1 h at room temperature under continuous stirring condition. Water-washed NAEBs were dispersed in 1.0 mL of 10 mM PBS buffer. Cross-linking of the sdAb was achieved by reacting the EDC-NHS activated carboxylated-NAEBs with single domain antibody overnight at 4° C., followed by PBS buffer wash to remove unbound protein.

Control NAEB (i.e., without sdAb) were prepared by reacting 1.0 mL of 3×10¹³/mL amine- or carboxylate-functionalized NAEBs with 2.0% BSA in PBS buffer overnight at room temperature. The beads were centrifuged and washed twice to remove excess BSA. Finally, the beads were re-dispersed in PBS buffer.

### Example 4

### Validation of sdAb Conjugation onto NAEB

To confirm conjugation of sdAb on NAEB, the sdAb-NAEB conjugate of Example 3 was exposed to the fluorescent protein A-phycoerythrin (PE) conjugate (Innova Biosciences, UK). The fluorescent PE protein absorbs in the visible (λab=495 nm) and has a strong emission at 575 nm. Successful conjugation of sdAb-NAEB was expected to exhibit PE fluorescence when exposed to the protein A-PE conjugates.

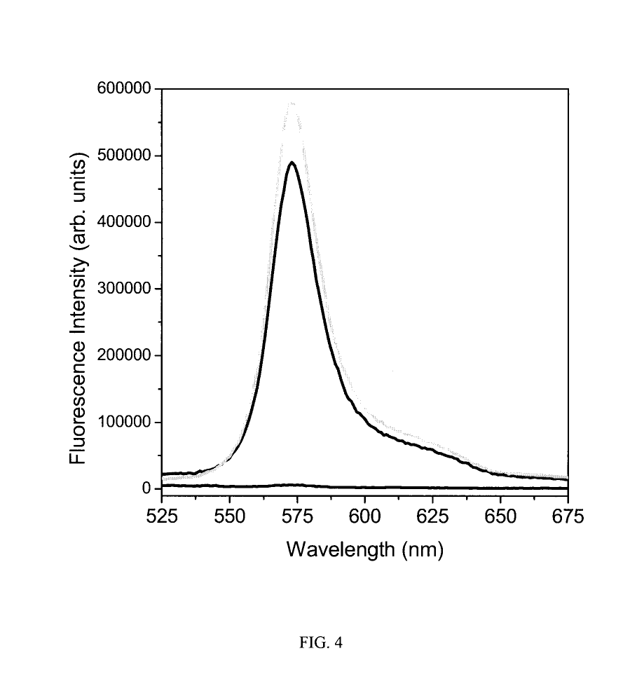

FIG. 4 shows the results of the fluorescence measurements from the control NAEB and sdAb-NAEB exposed to the protein A-PE conjugates. All the particles were exposed to the same concentration of protein A-PE conjugates and washed four times prior to fluorescence measurements. As the lower black trace in FIG. 4 shows, the control NAEB exhibit no fluorescent signal compared to the sdAb-NAEB (upper black trace and grey trace). The grey trace was obtained from samples prepared with the sdAb to NAEB ratio of 250 while the upper black curve was obtained from the lower sdAb to NAEB ratio of 125. An approximately 17% fluorescence intensity difference was observed between the upper black and grey traces of the sdAb-NAEB conjugates. This indicates that the loading of sdAb molecules on NAEB at a ratio of 125 molecules per NAEB likely did not saturate the surface of the NAEB. Ideally, one can continue to increase the loading ratio of sdAb to NAEB until the surface is completely saturated. In this study, even at a loading factor of 125, we observed satisfactory binding efficiency through the agglutination study. The loading factor of 125 sdAb per NAEB was used for the subsequent microagglutination assay and imaging studies.

### Example 5

### Bacterial Cell Culture and Microagglutination Assay

To demonstrate positive binding and enable subsequent SERS detection measurements, extensive microagglutination assays of the sdAb-NAEB conjugates of Example 3 were performed against target and control pathogens, S. aureus and Salmonella typhimurium, respectively.

Growth of cells: Staphylococcus aureus (ATCC 12598) and Salmonella typhimurium (ATCC 19585) were ordered from American Type Culture Collection (Manassas, Va.). A single colony of S. aureus from a Brain Heart Infusion (BHI) plate (EMD Chemicals Inc., Darmstadt, Germany) was inoculated into 10 mL of BHI broth and grown overnight at 37° C., 200 rpm. The next day, the culture was spun down in a fixed rotor, Sorval RT6000B refrigerated centrifuge at 5,000 rpm for 10 min. The cell pellet was resuspended in PBS, pH 7.0, and the cell density was measured at OD₆₀₀. The titer was determined by spreading serial dilutions of the cultures on BHI plates and incubating the plates overnight at 37° C. An OD₆₀₀ of 1.0 is equivalent to 1×10⁸ cells/mL. The S. typhimurium was prepared similarly using nutrient broth media (Becton, Dickinson and Company, Sparks, Md.). The OD₆₀₀ of 1.0 is equivalent to 3×10⁸ cells/mL.

Microagglutination assay: NAEB in PBS solution was serially diluted down the row to the 11^{th} microtiter plate well in PBS, with the 12^{th} row containing only PBS. The final well volume is 50 μL. To each well, one OD₆₀₀ unit of the appropriate cell sample in 50 μL buffer was added. The plate was incubated overnight at 4° C. In the morning, pictures of the plates were taken for further analysis. Agglutinated cells sediment as sheets at the bottom of wells whereas non-agglutinated cells sediment as dots. NAEB-single domain antibody conjugates are incubated with S. aureus cells during an agglutination assay. A small drop (1 μL) of the incubation solution is extracted and spotted on a flat and conductive substrate (such as silicon wafer) for optical and electron microscopy characterizations.

Although each sdAb contains only one protein A binding site, each NAEB contains more than 125 sdAb (see Example 4). Thus, each individual sdAb-NAEB acts as a multivalent binder capable of binding to multiple proteins A molecules on the surface of S. aureus cells. Moreover, each multivalent sdAb-NAEB can bind with more than one S. aureus cell, which results in cell agglutination.

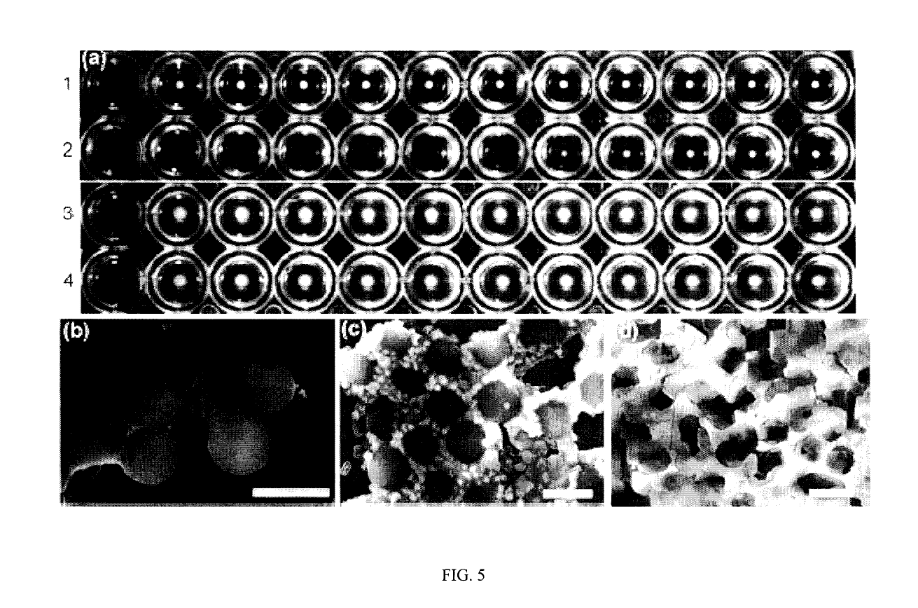

FIG. 5A shows results of the microagglutination assay. The NAEB concentration in each of the first wells was 3×10¹³ particles mL⁻¹. Cell concentrations were kept the same in all wells (˜10⁷ cells per well), whereas the NAEB concentration was decreased two-fold down each subsequent well. Rows 1 and 2 (FIG. 5A) show the control NAEBs (surface-terminated with carboxylate functional groups) and sdAb-NAEBs titrated against a constant number of S. aureus cells. Rows 3 (control NAEBs) and 4 (sdAb-NAEBs) of FIG. 5A represent titration against S. typhimurium cells under identical conditions. In each case, the last well (well 12) contained cells only.

Cell precipitation in a diffused sheet pattern at the centre of the wells (FIG. 5A, row 2) indicated a positive agglutination response of sdAb-NAEBs against S. aureus. Agglutination response was detected down to the eighth well in which the NAEB concentration was 2.34×10¹¹ particles mL⁻¹, corresponding to a particle concentration of 0.39 nm for the agglutination assay detection limit. Thus, the nanoaggregate embedded beads of the present invention agglutinated the cells more than 100-fold better that the pentamer (Ryan et al., 2009; MAC value, 3×10¹³ pentamer mL⁻¹), suggesting that the attached single domain antibodies may have a geometry that allows for a more sensitive detection of pathogenic bacteria. In the absence of agglutination, cells sediment out as round dots, as in the case of control NAEB against S. aureus (FIG. 5A, row 1) and sdAb-NAEBs against the control antigen S. typhimurium (FIG. 5A, row 4).

To further confirm the agglutination results, samples were taken from the agglutination assay well plate and examined under the scanning electron microscopy (SEM). SEM images in FIGS. 5B and D showed the lack of interaction between the control NAEBs against the S. aureus cells and the sdAb-NAEBs against the control organism (S. typhimurium). These SEM images mirror the negative agglutination response observed in the affinity binding assay (FIG. 5A, rows 1 and 3). In contrast, The SEM image (FIG. 5C) showed strong interaction between the sdAb-NAEBs and S. aureus in which the cells (dark sphere ˜1 μm) were well-coated with the sdAb-NAEB conjugates. Examining the NAEBs closely in FIG. 5C, one can see the Au nanoaggregates encapsulated inside each individual NAEB. Although the agglutination response was observable up to the eighth well (256-fold dilution of the particle concentration), it does not necessarily mean that the SERS detection is limited to that concentration. In fact, the sensitivity of NAEBs is extremely high, so that the SERS response from a single bead is detectable.

### Example 6

### Raman Spectroscopy

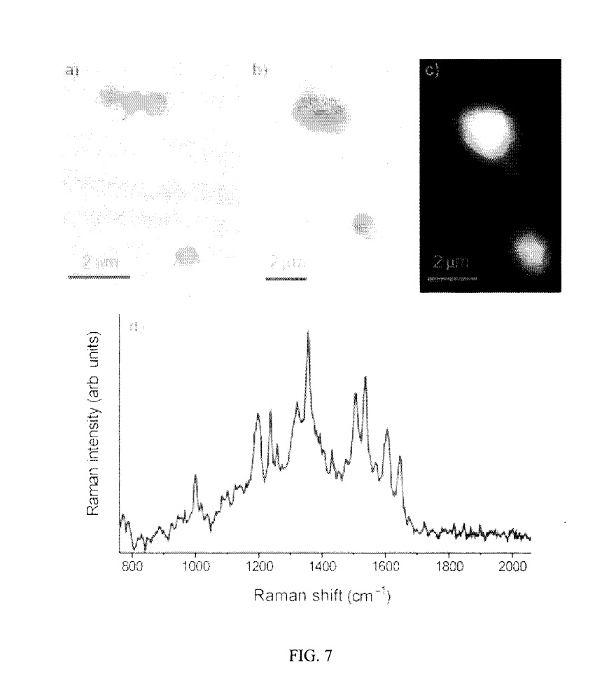

Raman spectroscopy and microscopy was performed by using a commercial microRaman system (LabRAM HR, Horiba-Jobin-Yvon) equipped with a software-controlled XY stage and a thermal-electric-cooled CCD detector. Samples were excited with λ=632.8 nm radiation at a power density of ˜10³ W cm⁻². Incident radiation was coupled into an Olympus BX51 optical microscope and focused to a ˜1 μm diameter spot through a 100× objective. The spectra for FIGS. 3B and 7D were collected with a one-second acquisition time. In the Raman mapping experiments, a fine set of grid points within an area of interest was defined in the software and imaged by rastering the sample under the tightly focused laser beam. At each of the grid points, a full Raman spectrum was acquired. Upon completion of the mapping, Raman intensity maps of specific vibrational modes were prepared by fitting the corresponding band and removing the associated background. This was achieved by using the Labspec 5.25 software (Horiba-Jobin-Yvon).

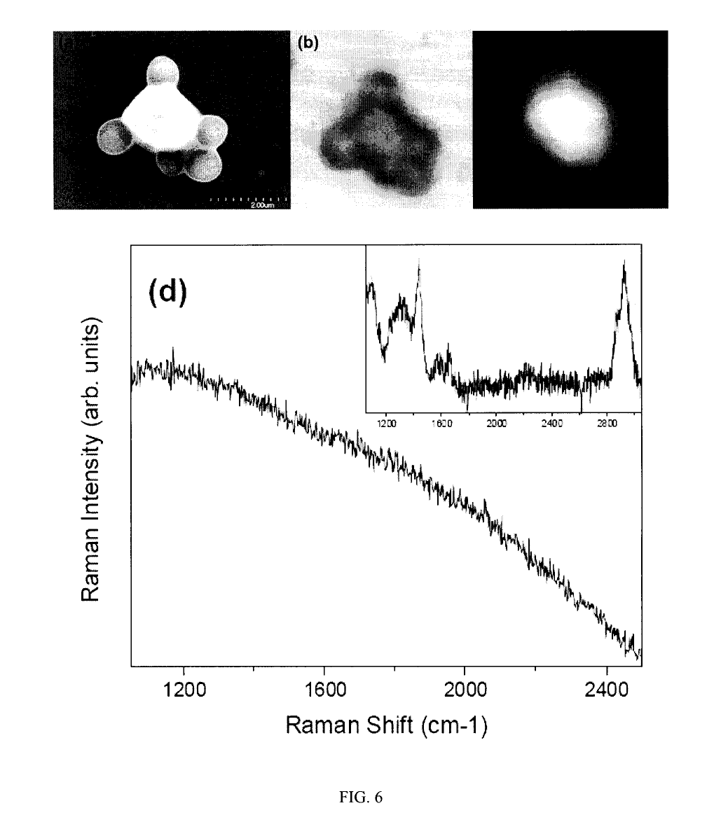

Raman imaging was carried out on cells that were treated with control NAEB of Example 3. Raman spectrum was acquired with 5-second acquisition time at an excitation power density of 10³ W/cm². FIGS. 6A, B and C show the SEM, optical and Raman images for the control experiment, respectively. These images contain a group of 5 cells clustered around a small salt crystal. No NAEB were observed in the SEM image. The thermal colored intensity map (FIG. 6C) is generated from the integrated area under the spectral region of 1040 to 2000 cm⁻¹. Although the intensity image displayed a bright spot co-localized with the presence of the cell. This is generated by the stronger Rayleigh scattering due to the presence of the salt crystal and cells. A spectrum extracted from the bright region (FIG. 6D) shows no distinct vibrational signature, but displays spectral characteristics of large scattering background component. Spectroscopic features from FIG. 6D indicate no presence of NAEB, which is consistent with the negative cell agglutination response in row 1 of FIG. 5A. Inset of 6D shows a Raman spectrum from a cluster of S. aureus cells (image not shown) acquired with 60 seconds accumulation and 10⁵ W/cm² power density.

Raman imaging of the S. aureus cells treated with sdAb-NAEBs is shown in FIGS. 7 (control NAEB are shown in FIG. 6). Here, two sets of sdAb-NAEB-labeled S. aureus cells are visible in the SEM image of FIG. 7A. The upper set consists of a group of three cells whereas the lower set is a single cell. Both sets of cells were well decorated with sdAb-NAEBs, which is indicative of the positive binding response between the sdAb-NAEBs and the targeted pathogen. An optical image of the same area is shown in FIG. 7B. The false-colored Raman intensity map (FIG. 7C) is constructed from the integrated intensity of the v=1196 and 1238 cm⁻¹ vibrational bands of R6G. Two bright regions were observed in the Raman intensity maps, demonstrating good spatial correlation to the cells observed in the optical (FIG. 7B) and SEM (FIG. 7A) images. FIG. 7D is a full SERS spectrum of the R6G-NAEBs taken from the single cell region (lower bright spot). The single cell from the Raman intensity map is clearly resolved and detected through sdAb-NAEB labeling. The specificity of the sdAb and the ultrahigh sensitivity of NAEBs render the targeted detection of S. aureus at the single-cell level easily attainable.

Although S. aureus exhibits a Raman signature that is native to all of the molecular biospecies that it contains, the Raman spectrum of S. aureus is generally two to three orders of magnitude less intense than the SERS signature from an individual NAEB. A S. aureus spectrum (FIG. 6D) showed vibration signatures of the amide I, III, and CH stretching bands that are typical of S. aureus cells and can be distinguished easily from the R6G spectrum used in the NAEBs. More importantly, because of the large difference in the scattering cross-section between the enhanced and un-enhanced molecules, the Raman bands of the cell components are generally not observable in the SERS imaging experiments

### REFERENCES

The following references are incorporated herein by reference (where permitted) as if reproduced in their entirety. All references are indicative of the level of skill of those skilled in the art to which this invention pertains.
Arbabi-Ghahroudi, M., To, R., Gaudette, N., Hirama, T., Ding, W., MacKenzie R., and Tanha, J. (2009). Aggregation-resistant VHs selected by in vitro evolution tend to have disulfide-bonded loops and acidic isoelectric points. Protein Eng. Des. Sel. 22:59-66.
Baker et al. Anal. Bioanal. Chem., (2005) 382, 1751-1770.
Cao, Y. C., Jin, R., Nam, J. M., Thaxtion, C. S, and Mirkin, C. A. (2003) J. Am. Chem. Soc. 125:14676-7.
Cao, Y. C., Jin, R. and Mirkin, C.A. (2002) Science 297:1536.
Dou, X., Takama, T., Yamaguchi, Y., Yamamoto, H. and Ozaki, Y. (1997) Anal. Chem. 69:1492-5.
Dooley, H., Flajnik, M. F., and Porter, A. J. (2003). Selection and characterization of naturally occurring single-domain (IgNAR) antibody fragments from immunized sharks by phage display. Mol. Immunol. 40: 25-33.
Driskell, J. D., Kwarta, K. M., Lipert, R. J., Porter, M. D., Neill, J. D., Ridpath, J. F. (2005) Anal. Chem. 77:6147-54.
Frens, G. Nat. Phys. Sci. (1973) 241, 22-24.
Grubisha, D. S., Lipert, R. J., Park, H. Y., Driskell, J. and Porter, M. D. (2003) Anal. Chem. 75: 5936-43.
Harmsen, M. M. and de Haard, H. J. (2007). Properties, production, and applications of camelid single-domain antibody fragments. Appl. Microbiol. Biotechnol. 77: 13-22.
He, L., Musick, M. D., Nicewarner, S. R., Salinas, F. G., Benkovic, S. J., Natan, M. J. and Keating, C.D. (2000) J. Am. Chem. Soc. 122:9071-7.
Holliger, P. and Hudson, P. J. (2005). Engineered antibody fragments and the rise of single domains. Nat. Biotechnol. 23: 1126-1136.
Holt, L. J., Herring, C., Jespers, L. S., Woolven, B. P., and Tomlinson, I. M. (2003). Domain antibodies: proteins for therapy. Trends Biotechnol. 21: 484-490.
Hoogenboom, H. R. (2005). Selecting and screening recombinant antibody libraries. Nat. Biotechnol. 23: 1105-1116.
Huang, P., Tay, L., Tanha, J., Ryan, S, and Chau, L. (2009) Targeted detection of pathogenic bacteria, Staphylococcus aureus, with nano-aggregate embedded beads. Chem. Europ. J., 15: 9330-9334.
Huang P.-J., L.-K. Chau, T.-S. Yang, L.-L. Tay, T.-T. Lin, (2009b) Adv. Funct. Mater. 19, 242-248.
Jarvis, R. M. and Goodacre, R. (2004) Anal. Chem. 76:40-7.
Jespers, L., Schon, O., Famm, K., and Winter, G. (2004a). Aggregation-resistant domain antibodies selected on phage by heat denaturation. Nat. Biotechnol. 22: 1161-1165.
Jespers, L., Schon, O., James, L. C., Veprintsev, D., and Winter, G. (2004b). Crystal Structure of HEL4, a Soluble, Refoldable Human VH Single Domain with a Germ-line Scaffold. J. Mol. Biol. 337: 893-903.
Kneipp, K., Wang, Y., Kneipp, H., Perelman, L. T., Itzkan, I., Dasari, R., Feld, M. S. (1997) Phy. Rev. Lett. 78(9):1667-70.
Kortt, A. A., Dolezal, O., Power, B. E. and Hudson, P. J. (2001) Biomol. Eng. 18:95-108.
Lee, Meisel J. Phys. Chem., (1982) 86, 3391-3395
L. Levy, Y. Sahoo, K.-S. Kim, E. J. Bergey, P. N. Prasad, Langmuir 2002, 14, 3715-3721
Liu, J. L., Anderson, G. P., Delehanty, J. B., Baumann, R., Hayhurst, A., and Goldman, E. R. (2007). Selection of cholera toxin specific IgNAR single-domain antibodies from a naive shark library. Mol. Immunol. 44: 1775-1783.
Michaels, A. M., Nirmal, M. and Brus, L. E. (1999) J. Am. Chem. Soc. 121:9932-9.
Moskovits, M. (1985) Rev. Mod. Phys. 57:783.
Moskovits, M. J. (2005) Raman Spectros. 36:485-96.
Ni, J., Lipert, R. J., Dawson, G. B. and Porter, M.D. (1999) Anal. Chem. 71:4903-8.
Nuttall, S. D., Irving, R. A., and Hudson, P. J. (2000). Immunoglobulin VH domains and beyond: design and selection of single-domain binding and targeting reagents. Curr. Pharm. Biotechnol. 1: 253-263.
Nuttall, S. D., Krishnan, U. V., Hattarki, M., De Gori, R., Irving, R. A., and Hudson, P. J. (2001). Isolation of the new antigen receptor from wobbegong sharks, and use as a scaffold for the display of protein loop libraries. Mol. Immunol. 38: 313-326.
Power, B.E., Doughty, L., Sharpia, D. R., Bayly, A. M. and Caine, J. M. (2003) Protein Sci. 12:737-747.
Revets, H., De Baetselier, P., and Muyldermans, S. (2005). Nanobodies as novel agents for cancer therapy. Expert. Opin. Biol. Ther. 5: 111-124.
Ryan, S., Kell, A., van Faassen, H., Simard, B., Tay, L. MacKenzie, R., Michel Gilbert, M., Tanha, J. (2009) Single-Domain Antibody-Nanoparticles: Promising Architectures for Increased Staphylococcus aureus Detection Specificity and Sensitivity. Bioconjugate Chem. 20: 1966-1974.

Soukka, T., Harma, H., Paukkunen, J. and Lovgren, T. (2001) Anal. Chem. 73:2254-60.
Tanha, J. A method for high throughput screening of proteins. U.S. Provisional Patent Application Ser. No. 60/664,954, filed March 2005.
Tanha, J., Dubuc, G., Hirama, T., Narang, S. A., and MacKenzie, C. R. (2002). Selection by phage display of llama conventional V(H) fragments with heavy chain antibody V(H)H properties. J. Immunol. Methods 263: 97-109.
Tanha, J., Nguyen, T. D., Ng, A., Ryan, S., Ni, F., and MacKenzie, R. (2006). Improving solubility and refolding efficiency of human V(H)s by a novel mutational approach. Protein Eng Des Sel 19: 503-509.
Tanha, J., Xu, P., Chen, Z. G., Ni, F., Kaplan, H., Narang, S. A., and MacKenzie, C. R. (2001). Optimal design features of camelized human single-domain antibody libraries. J. Biol. Chem. 276: 24774-24780.
To, R., Hirama, T., Arbabi-Ghahroudi, M., MacKenzie, C. R., Wang, P., Xu, P., Ni, F. and Tanha, J. (2005) Isolation of monomeric human V_{H}S by a phage selection. J. Biol. Chem. 280:41395-403.
Todorovska, A., Roovers, R. C., Dolezal, O., Korn, A. A., Hoogenboom, H. R. and Hudson, P. J. (2001) J. Immunol. Methods 248:47-88.
Xu, H. X., Bjerneld, E. J., Kall, M. and Borjesson, L. (1999) Phys. Rev. Lett. 83:4357-60.
Xu, S. P., Ji, X. H., Xu, W. Q., Wang, L. Y., Bai, Y. B., Zhao, B. and Ozaki, Y. (2004) Analyst 129:63-8.
Valanne, A., Huopalahti, S., Soukka, T., Vainionanoparticlesaa, R., Lonnberg, S., Lovgren, T. and Harma, H. (2005) Clin. Chem. 33:217-223.
S. L. Westcott, S. J. Oldenburg, T. R. Lee, N. J. Halas, Langmuir 1998, 14, 5396-5410
Zhang, J., Tanha, J., Hirama, T., Khieu, N. H., To, R., Tong-Sevinc, H., Stone, E., Brisson, J. and Mackenzie, C. R. (2004) J. Mol. Biol. 335:49-56.
Zhao, X., Hillard, L. R., Mechery, S. J., Wang, Y., Bagwe, R. P., Jin, S, and Tan, W. (2004) Proc. Nat. Acad. Sci. 101:15027-32.

We claim:

1. A nanoaggregate embedded bead, comprising:
(a) an inner core comprising one or more metallic nanoparticles and one or more Raman active reporter molecules;
(b) an outer shell; and
(c) one or more single-domain antibody (sdAb).

2. The nanoaggregate embedded bead of claim 1, wherein the metallic nanoparticles are selected from gold, silver, copper, aluminium, their alloys, or combinations thereof.

3. The nanoaggregate embedded bead of claim 2, wherein the metallic nanoparticles are gold or silver.

4. The nanoaggregate embedded bead of any one of claims 1 to 3, wherein the Raman-active reporter molecule may comprise at least one organic compound.

5. The nanoaggregate embedded bead of claim 4, wherein the organic compound comprises at least one isothiocyanate, thiol, or amine group, or multiple sulfur atoms, or multiple nitrogen atoms.

6. The nanoaggregate embedded bead of claim 4, wherein the organic compound comprise rhodamine 6G (R6G), tetramethyl-rhodamine-5-isothiocyanate, X-rhodamine-5-(and -6)-isothiocyanate, or 3,3′-diethylthiadicarbocyanine iodine.

7. The nanoaggregate embedded bead of any one of claims 1 to 6, wherein the outer shell comprises silica or a polymer.

8. The nanoaggregate embedded bead of any one of claims 1 to 7, wherein the sdAb is specific to a pathogen.

9. The nanoaggregate embedded bead of any one of claims 1 to 7, wherein the sdAb is specific to protein A on the surface of Staphylococcus aureus.

10. The nanoaggregate embedded bead of claim 8, wherein the sdAb comprises the sequence of SEQ ID NO. 1 or a substantially identical sequence thereto.

11. The nanoaggregate embedded bead of claim 8, wherein the sdAb is HVHP428.

12. A method of identifying an analyte in a sample, comprising the steps of:
(a) contacting the sample with a nanoaggregate embedded bead of any one of claims 1 to 7, wherein the sdAb specifically binds to the analyte; and
(b) detecting the nanoaggregate embedded bead with surface enhanced Raman scattering spectroscopy or microscopy.

13. A method of detecting one or more than one pathogen of interest in a mixed culture or sample, comprising the steps of:
(a) binding the pathogen with a nanoaggregate embedded bead of any one of claims 1 to 7, wherein the sdAb is specific for the pathogen; and
(b) detecting the nanoaggregate embedded bead with surface enhanced Raman scattering spectroscopy or microscopy.

14. The method of claim 13, wherein the pathogen is selected from the group consisting of Campylobacter spp., Staphylococcus aureus, Francisella tularensis, Salmonella, E. coli O157:H7, Shigella, Clostridium difficile, and Listeria.

15. A method of detecting Staphylococcus aureus in a mixed culture or sample, comprising the steps of:
(a) binding the pathogen with a nanoaggregate embedded bead of any one of claims 8 to 11; and
(b) detecting the nanoaggregate embedded bead with surface enhanced Raman scattering spectroscopy or microscopy.
